(19) United States
(12) Patent Application Publication
(10) Pub. No.: US 2023/0240463 A1
(43) Pub. Date: Aug. 3, 2023

(54) Low-pressure steam cooker

(71) Applicant: Denk Keramische Werkstätten e.K., Coburg (DE)

(72) Inventor: Fabian Denk, Coburg (DE)

(21) Appl. No.: 18/069,310

(22) Filed: Dec. 21, 2022

(30) Foreign Application Priority Data
Jan. 28, 2022 (DE) 10 2022 101 981.0

(51) Int. Cl. A47J 27/08

(52) U.S. Cl. CPC A47J 27/08

(57) ABSTRACT

A low-pressure steam cooker comprises a base plate and low-pressure hood. The base plate has a base surface and cooking product surface opposite the base surface. The cooking product surface has a hood bearing surface having a peripheral raised retaining edge and at least one water trough for holding water. The low-pressure hood has a dish-shaped hood volume and a mounting rim, the contour of which is shaped complementary to the contour of the retaining edge of the base plate, so that the mounting rim is enclosed by the retaining edge when the mounting rim is seated on the hood bearing surface. The base plate and low-pressure hood are each formed of a non-glazed ceramic material. The surfaces of the mounting rim and the hood bearing surface facing each other are formed so that a steam outlet gap remains therebetween, at least in sections.

### CROSS-REFERENCE TO RELATED APPLICATION

This application claims priority to German Application No. DE102022101981.0, filed Jan. 28, 2022, the contents of which are incorporated herein by reference.

### BACKGROUND OF THE INVENTION

The invention relates to a low-pressure steam cooker comprising at least one base plate and a low-pressure hood. The base plate has a downwardly directed base surface and an upwardly directed cooking product surface. The cooking product surface has a hood bearing surface having a circumferential raised retaining edge and at least one water trough for holding water. The low-pressure hood has a mounting rim, the contour of which is shaped complementary to the contour of the retaining edge of the base plate, so that the mounting rim is enclosed by the retaining edge when the mounting rim of the low-pressure hood is seated on the hood bearing surface of the base plate.

In practice, there are numerous vessels and utensils used in the preparation of food. In addition to conventional ovens and microwave ovens, so-called steam cookers are also known for heating food, in the cooking chamber of which a steam atmosphere is generated in order to, for example, gently heat vegetables. These steam cookers are technically complex and take up space in the kitchen. There are moreover devices that contain a volume of water and are used to place food in an oven to simulate a steam atmosphere. The extensive escape of water vapor can, however, cause damage to the oven, which is not designed for these applications. In addition, no steam pressure that significantly exceeds the room pressure can be generated, which adversely affects the cooking time and the cooking result.

A steam lid that comprises two opposing concave spaces is known from US 2017/071405 A1, one of the concave spaces being used for covering food and the other concave space serving as a liquid reservoir, in particular for water. The water can reach a hot surface and evaporate passing through a liquid channel connecting the two spaces.

JP 2013-255626 A describes a ceramic container. The container is formed by a plurality of layers, wherein a heating element layer is applied on a base layer and another layer is applied on top of the base layer. In particular, the container is suitable for use in microwave ovens.

A heat-resistant ceramic container that is used for heating food in microwave ovens is disclosed in JP 2005-328880 A.

A grilling accessory is described in US 2019/0183152 A1. The grilling accessory comprises a cover, that forms a steaming region under the cover. The grilling accessory moreover comprises a steam generator having at least one vent opening, wherein the steam generator absorbs and holds liquids under the cover. The steam generated in the steam generator enters the steaming region through the vent opening.

Based on the identified deficiencies, one task of the present invention, is to provide a low-pressure steam cooker that is usable in both an oven and a microwave oven, which steam cooker provides a low-pressure steam atmosphere in which a food to be cooked can be cooked in a short time without excessive escape of steam.

This task is solved by a low-pressure steam cooker according to the appended claim 1. preferred embodiments of the invention are named in the dependent claims and described in more detail below.

### SUMMARY OF THE INVENTION

The low-pressure steam cooker according to the invention firstly comprises a base plate having a base surface directed downward in the operating state and a cooking product surface laying opposite to the base surface. The food to be cooked is placed on the cooking product surface, for example vegetables, potatoes or similar food to be prepared in hot steam. The cooking product surface has a hood bearing surface having a circumferential, raised retaining edge and at least one water trough for holding water, which water is evaporated during the cooking process.

Another component of the low-pressure steam cooker is a low-pressure hood having a dish-shaped hood volume and a mounting rim, the contour of which is shaped to be complementary to the contour of the retaining edge of the base plate. When the low-pressure hood is placed on the base plate for the cooking process, the mounting rim of the low-pressure hood is enclosed by the retaining edge.

It is also essential for the invention that the base plate and the low-pressure hood are each formed in one piece and consist of a non-glazed ceramic material, the raw ceramic material of which is admixed with granite meal before the sintering process.

The water trough has a water absorption volume in the range of 1% to 2% of the hood volume. This volume ratio is significant for the functionality, since in this way the correct amount of water is available for steam generation. The surfaces facing each other of the mounting rim of the low-pressure hood and the hood bearing surface of the base plate are shaped in such a way that, at least in sections, a steam outlet gap remains between them. This is necessary in order for the steam generated under the hood to be able to escape in a restricted manner, so that there is a pressure under the hood that is slightly higher than the ambient pressure, which promotes the cooking process.

When using the low-pressure steam cooker, water is filled into the water trough in the base plate. The food to be cooked, for example, potatoes or vegetables, are placed on the cooking product surface. Then the low-pressure hood is placed on the base plate so that the mounting rim comes to rest on the hood bearing surface and the food to be cooked is enclosed in the hood volume. The volume of the water trough determines the amount of water that can be introduced, which is adapted to the hood volume according to the invention. A usable water volume of 1% to 2% of the hood volume provides sufficient water for a cooking process, and at the same time the water is largely evaporated at the end of the cooking process, so that the low-pressure steam cooker can be removed from the heating apparatus more easily.

The heating of the low-pressure steam cooker and the food to be cooked deposited in it takes place in the oven or in a microwave oven. During cooking in the oven, the water evaporates and hot steam forms under the hood. At the same time, the ceramics of the base plate and the low-pressure hood store the heat supplied by the oven and release it to the food to be cooked as radiant heat with a time delay but very evenly. It has been shown that in comparison to heating in a water bath, only a very small amount of water needs to be heated, which contributes significantly to energy savings during cooking.

Moreover, the cooking process with the low-pressure steam cooker can also be used in a microwave oven. The energy-saving cooking in the microwave oven is further improved by a special property of the ceramic used in the low-pressure steam cooker, which is also referred to below as granite ceramic. In contrast with porcelain, glass or plastics, this ceramic is excited by microwave radiation and heats up itself. As a result, the food to be cooked is subjected not only to microwave radiation but also to uniform radiant heat from the granite ceramic material from which the base plate and the low-pressure hood are made. As with heating in an oven, water is evaporated from the water trough, so that the water vapor acts on the food to be cooked in addition to the microwave radiation. The cooking process according to this principle takes place very quickly, saving energy while also being gentler than if the food to be cooked were exposed exclusively to direct microwave radiation.

Water vapor forms in the low-pressure steam cooker during heating. This can escape through the steam outlet gap once a limited minimum pressure, for example, of about 1 bar, is reached, since the low-pressure hood does not seal against the base plate. This prevents dangerous overpressure from forming, as is the case, for example, with pressure cookers. Moreover, cooking under low steam pressure has the advantage that possible impurities and contaminants on the food to be cooked, for example, on the potato skin, are not pressed into the interior of the food to be cooked.

After the cooking process, the low-pressure steam cooker can be removed from the oven or microwave oven. To remove the cooked food, either the low-pressure hood is lifted off the base plate or the low-pressure steam cooker is turned 180° so that the food comes to rest in the low-pressure hood. Preferably, the low-pressure hood has an outwardly directed support surface on its upper side opposite the mounting rim, so that it can be set down as a dish with the food that it contains. The heated material of the low-pressure hood then keeps the food warm for a particularly long time.

The use of granite ceramic for the low-pressure hood and the base plate offers further advantages over other materials. Previously known cooking containers made of plastics have only limited temperature resistance. Furthermore, plastics contain plasticizers necessary for molding. These can migrate into the food when it comes into contact with the food, posing a risk of adverse health effects. Furthermore, the perceived taste of the food to be cooked can be impaired. Granite ceramics, on the other hand, are particularly suitable for food contact, as confirmed by appropriate tests. The material is chemically inert and there is no migration of substances. This means that there is no risk of adverse effects on health or taste. Moreover, the ceramic is temperature-resistant up to at least 800° C., so that no material damage occurs even when exposed to direct flame in a gas stove.

The low-pressure steam cooker made of granite ceramics, however, also offers considerable advantages over metal cooking containers. Metal containers cannot be used in microwave ovens since they reflect microwave radiation, which can lead to destruction of the microwave oven.

In general, the hard surface of granite ceramics and their low water absorption allow cleaning in the dishwasher or by hand, even with aggressive cleaning agents. Granite ceramics are chemically inert, so that no surface changes occur. No food particles can adhere to the surface. The risk of mold formation can in this way effectively be prevented.

In the manufacture of so-called granite ceramics, fine-grained granite meal is admixed to the raw material. The sintered ceramic is densely fired, chemically inert, offers hardly any attack surfaces for bacteria and odors, and can be easily cleaned, for example, with a soap solution or, in the case of special requirements, with weak acids and alkalis. Through the use of molding or casting technology, it is possible that the thickness of the material of the ceramic can be kept relatively thin and thus the low-pressure hood can, in particular, be kept lightweight.

The low-pressure steam cooker is particularly preferably made of a non-glazed ceramic to which titanium oxide has been admixed during the manufacturing process. This produces a bactericidal surface. The material treated in this way is chemically inert and suitable for foodstuffs. Anatase and rutile pigments form on the surface of the pottery sherds as variations of titanium oxide during firing above 800° C. These pigments are photocatalytically active. When exposed to light in combination with atmospheric oxygen and humidity, free reactive hydroxyl and peroxyl radicals are formed. These free radicals react with adjacent organic compounds (such as, for example, bacteria) and destroy them. Preferably, about 2% of titanium dioxide is admixed to the ceramic raw material, whereby a functional, microscopically visible surface effect is established due to rutile and anatase pigments. The pigments are bonded in the ceramic and cannot be detached or alternatively flushed out. As a result of this measure, the ceramic used has a bactericidal effect and thus increases the maximum storage life of foodstuffs.

An advantageous embodiment is characterized in that the base plate and its retaining edge, as well as the mounting rim of the low-pressure hood, each have a circular outer contour, wherein the outer diameter of the mounting rim is slightly smaller than the inner diameter of the retaining edge. Of course, other basic shapes are also possible, for example, oval, rectangular and the like.

Preferably, the water trough is formed as a communicating channel system in the cooking product surface. In particular, it is advantageous if the channel system of the water trough comprises a plurality of concentrically extending channel sections and a plurality of radial extending channel sections. In this manner, the water is available in an evenly distributed manner so that the water vapor formed flows around all sides of the food to be cooked. Parts of the cooking product surface remain in sections between the channels.

A particularly advantageous embodiment is one in which the bottom lines of the channel sections run in a lower plane, the cooking product surface in a middle plane and the upper edge of the retaining edge in an upper plane, wherein these three planes run parallel to one another and the middle plane is positioned closer to the lower than to the upper plane.

According to one embodiment, the mounting rim and the hood bearing surface have a surface roughness with an average roughness of Ra>100 μm. This leads to an adequate shape of the steam outlet gap, which in this way is also particularly evenly distributed along the mounting rim.

In a modified embodiment, the ceramic material contains microwave-absorbing components, in particular dark micaceous minerals.

### DESCRIPTION OF THE DRAWINGS

Further advantages and details of the invention will be apparent from the following description of a preferred embodiment, with reference to the drawing. Wherein:

FIG. 1 shows a top view of an embodiment of a base plate of a low-pressure steam cooker according to the invention;

FIG. 2 shows a perspective view of a low-pressure hood of a low-pressure steam cooker;

FIG. 3 shows a cross-sectional view of the low-pressure steam cooker.

### DETAILED DESCRIPTION OF THE INVENTION

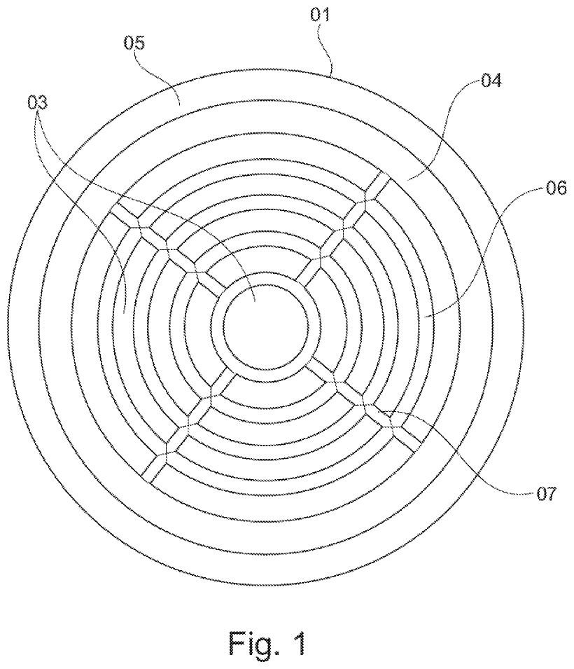

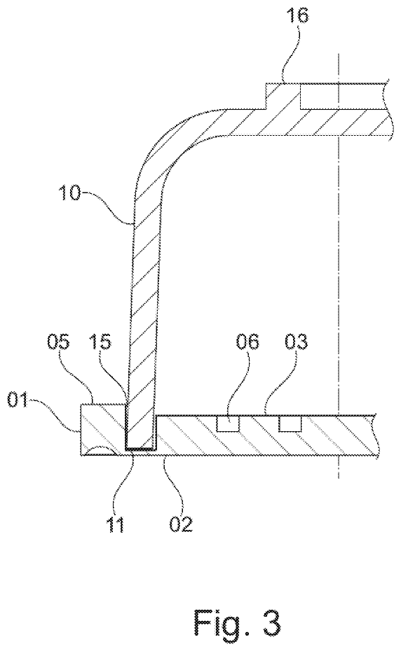

FIG. 1 shows a simplified top view of a disc- or plate-shaped base plate 01 of a low-pressure steam cooker according to the invention. The base plate 01 has a base surface 02 (FIG. 3) and a cooking product surface 03 laying opposite the base surface. In the embodiment shown, the cooking product surface 03 is formed by numerous sections which preferably lie in a common middle plane. The cooking product surface has a hood bearing surface 04 in the outer area having a circumferential, raised retaining edge 05. The base plate has, for example, a diameter D_{G}=24 cm, a height H_{G}=1.5 cm and, with these exemplary dimensions, a weight of about G_{G}=1,080 g.

The cooking product surface 03 has at least one water trough, which in the embodiment shown is formed by concentrically extending channel sections 06 and radial extending channel sections 07, which are in communication with each other. Preferably, all channel sections are formed with the same depth and their bottom lines thus extend in a common lower plane. The water trough 06, 07 serves to hold water during the cooking process. The water trough advantageously has a volume V_{M}=30 ml.

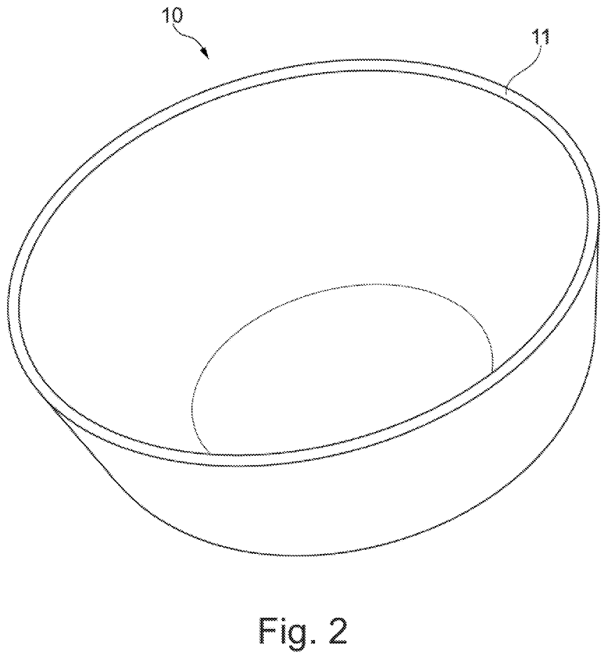

FIG. 2 shows a dish-shaped low-pressure hood 10 in a perspective view, which low-pressure hood forms the second component of the low-pressure steam cooker. The low-pressure hood 10 has, for example, a hood volume V_{H}=1,700 ml, a diameter D_{H}=20.5 cm, a height H_{H}=9.5 cm, and, with these dimensions, for example, a weight G_{V}=1,170 g.

The low-pressure hood 10 has a mounting rim 11 in the plane of its opening, the contour of which is shaped complementary to the contour of the retaining edge 05 of the base plate 01, such that the mounting rim 11 is enclosed by the retaining edge 05 when the mounting rim of the low-pressure hood is seated on the hood bearing surface of the base plate (FIG. 3).

The base plate 01 and the low-pressure hood 10 are each formed in one piece from a non-glazed ceramic material, the ceramic raw material of which is admixed with granite meal. Even with modified dimensions, the water absorption volume V_{M} of the water trough is about 1% to 2% of the hood volume V_{H}, preferably 1.5% to 1.9%, particularly preferably 1.764%. The water absorption of the sintered granite ceramic is similar to that of porcelain or alternatively porcelain stoneware and is preferably <0.5%. The ceramic should have a high heat capacity such that there is uniform transfer of heat to the food to be cooked. Moreover, good heat storage serves to keep the food warm for a long time after cooking. Depending on its composition, the heat capacity of granite ceramics is up to approx. 1.2 J g⁻¹ K⁻¹. In this manner, a higher heat storage capacity than steel is provided. The granite ceramic is excited by microwave radiation and is thereby heated. On the other hand, granite ceramic does not absorb so much of the microwave radiation that the effect on the food would be too small. The granite meal added to the ceramic raw material contains quartz, feldspar and mica. In particular, the dark micaceous minerals contained absorb microwave radiation, and the material heats up much more strongly than with white porcelain.

FIG. 3 shows a cutaway view of the low-pressure steam cooker in assembled form as it is used for cooking food. It can be seen that the mounting rim 11 of the low-pressure hood is seated on the hood bearing surface 04 and is enclosed around the outer periphery by the retaining edge 05. The surfaces of the mounting rim 11 and the hood bearing surface 04 facing each other are formed in such a way that, preferably by increased surface roughness, a steam outlet gap 15 remains between them, at least in sections, through which gap the water vapor produced during heating can escape. To allow the steam generated during use to escape, the hood must not seal tightly with the base plate. This is ensured by the use of coarse mass components in the ceramic. The components have sizes of up to 2 mm. As a result, the contact surface is always designed in such a way that water vapor of a pressure of more than 1 bar can escape.

It is also visible in FIG. 3 that the low-pressure hood 10, on its upper side opposite the mounting rim has an outwardly directed support surface 16. The support surface 16 is used when the low-pressure hood is used as a dish after the cooking process.

1. Low-pressure steam cooker comprising:
a base plate having a base surface and a cooking product surface laying opposite it, wherein the cooking product surface has a hood bearing surface having a circumferential, raised retaining edge, and wherein the cooking product surface has at least one water trough for holding water;
a low-pressure hood having a dish-shaped hood volume and a mounting rim, the contour of which is shaped complementary to the contour of the retaining edge of the base plate, so that the mounting rim is enclosed by the retaining edge when the mounting rim is seated on the hood bearing surface;
wherein the base plate and the low-pressure hood are each formed of a non-glazed ceramic material, the ceramic raw material of which was admixed with granite meal; wherein the water trough has a water absorption volume in the range of 1% to 2% of the hood volume; and
wherein the surfaces of the mounting rim and the hood bearing surface facing each other are formed in such a way that a steam outlet gap remains between them, at least in sections.

2. Low-pressure steam cooker according to claim 1, where the base plate and its retaining edge as well as the mounting rim of the low-pressure hood each have a circular outer contour, wherein the outer diameter of the mounting rim is slightly smaller than the inner diameter of the retaining edge.

3. Low-pressure steam cooker according to claim 1, wherein the water trough is formed by a communicating channel system in the cooking product surface.

4. Low-pressure steam cooker according to claim 3, wherein the channel system of the water trough comprises a plurality of concentrically extending channel sections and a plurality of radial extending channel sections.

5. Low-pressure steam cooker according to claim 4, wherein the bottom lines of the concentrically extending channel sections and the radially extending channel sections extend in a lower plane, the cooking product surface extends in a middle plane and the upper edge of the retaining edge extends in an upper plane, wherein these three planes extend parallel to each other and wherein the middle plane is positioned closer to the lower than to the upper plane.

6. Low-pressure steam cooker according to claim 1, wherein the mounting rim and the hood bearing surface (04) have a surface roughness with an average roughness Ra>100 μm.

7. Low-pressure steam cooker according to claim 1, wherein the low-pressure hood has an outwardly directed support surface on its upper side opposite the mounting rim.

8. Low-pressure steam cooker according to claim 1, wherein base plate and low-pressure hood consist of a waterproof ceramic material.

9. Low-pressure steam cooker according to claim 8, wherein the ceramic material contains microwave-absorbing components, in particular dark micaceous minerals.

10. Low-pressure steam cooker according to claim 1, wherein titanium oxide was admixed to the ceramic raw material during the manufacture of the base plate and the low-pressure hood.
